(19) United States
(12) Patent Application Publication
(10) Pub. No.: US 2001/0043307 A1
(43) Pub. Date: Nov. 22, 2001

(54) Method of manufacturing a liquid crystal panel

(75) Inventors: Keiichi Furukawa, Suita-Shi (JP); Kosuke Sasai, Kobe-Shi (JP)

Correspondence Address: SIDLEY AUSTIN BROWN & WOOD, 717 NORTH HARWOOD, SUITE 3400, DALLAS, TX, 75201, US

(73) Assignee: Minolta Co., Ltd.

(21) Appl. No.: 09/858,982

(22) Filed: May 16, 2001

(30) Foreign Application Priority Data
May 19, 2000 (JP) 2000-147362
Apr. 16, 2001 (JP) 2001-116463

(51) Int. Cl. G02F 1/1339

(52) U.S. Cl. 349/190

(57) ABSTRACT

The invention is directed to a manufacturing method of a liquid crystal panel having first and second substrates, between which a liquid crystal layer and a seal wall surrounding the liquid crystal layer are sandwiched, includes the steps of (a) forming a seal wall precursor on the first substrate; (b) executing a preliminary hardening of the precursor; (c) laminating the first and second substrates with sandwiching the preliminarily and suitably hardened seal wall and a liquid crystal layer therebetween; and (d) executing, after step (c), a main hardening of the seal wall material. The invention is also directed to a manufacturing method of layered type liquid crystal panel including a plurality of such liquid crystal panels layered together.

The invention is based on Japanese Patent Application Nos. 2000-147362 and 2001-116463 filed in Japan on May 19, 2000 and Apr. 16, 2001, respectively, the entire contents of which are hereby incorporated by reference.

### BACKGROUND OF THE INVENTION

1. Field of the Invention

The present invention relates to a method of manufacturing a liquid crystal panel, in which a liquid crystal layer and a seal wall surrounding the liquid crystal layer are held or sandwiched between two substrates. Further, the invention relates to a method of manufacturing a layered type liquid crystal panel including a plurality of such liquid crystal panels layered together.

2. Description of the Related Art

Various types of liquid crystal panels have been known. One of the known liquid crystal panels has such a structure that two substrates are opposed to each other with a predetermined gap therebetween, the gap between the substrates is filled with a liquid crystal layer, and the liquid crystal layer is surrounded by a seal wall. For manufacturing this type of liquid crystal panel, for example, first and second substrates are fixed together, with holding the liquid crystal layer and the seal wall surrounding the liquid crystal layer therebetween, and the seal wall itself may be used as an agent providing adhesion.

However, the fixing or bonding of the substrates must be reliable. For suppressing a distortion in the panel, irregularities in display and others, the gap between the first and second substrates including a portion near the seal wall must be as uniform as possible after bonding the substrates.

Further, it is also necessary to suppress dissolving of a seal wall material in a liquid crystal material for suppressing occurrence of a display failure.

For manufacturing a multilayer liquid crystal panel of the type, in which a plurality of liquid crystal panels are layered together, each liquid crystal panel must be manufactured in a similar manner.

For example, in the case of manufacturing a color display panel including a multilayer structure of panels for display in red, green and blue, respectively, irregularities may be present in the gap between the substrates near the seal wall in each of the panels. In this case, a large distortion occurs in the whole multilayer panel so that the sizes and/or configurations may fall outside predetermined ranges, and/or a display failure may occur.

In view of the above, further improvements have been demanded for the method of manufacturing the liquid crystal panel, in which the liquid crystal layer and the seal wall surrounding the liquid crystal layer are held between the first and second substrates.

### SUMMARY OF THE INVENTION

An object of the invention is to provide a manufacturing method of a liquid crystal panel having first and second substrates between which a liquid crystal layer and a seal wall surrounding the liquid crystal layer are sandwiched, and particularly a liquid crystal panel manufacturing method, which can reliably bond the first and second substrates together, can provide a uniform gap between the substrates even at the vicinity of the seal wall, can suppress dissolving of a seal wall material in a liquid crystal, and thereby can provide the liquid crystal panel capable of better display.

Another object of the invention is to provide a manufacturing method of a layered type liquid crystal panel formed of a plurality of liquid crystal panels layered together and each having first and second substrates, between which a liquid crystal layer and a seal wall surrounding the liquid crystal layer are sandwiched, and particularly a layered type liquid crystal panel manufacturing method, which can reliably bond the first and second substrates of each liquid crystal panel together, can provide a uniform gap between the substrates even at the vicinity of the seal wall in each liquid crystal panel, can suppress dissolving of a seal wall material in a liquid crystal, and thereby can provide the layered type liquid crystal panel capable of better display.

For achieving the above objects, the inventors have studied to find the followings:

For manufacturing a liquid crystal panel having first and second substrates between which a liquid crystal layer and a seal wall surrounding the liquid crystal layer are sandwiched, for example, the seal wall may be made of a seal wall material such as thermosetting resin, which is hardened by heating.

Such a manner may be employed that a seal wall precursor made of the seal wall material is formed on one of the substrates, and is hardened to attain an appropriate hardness (half-hardened state) by preliminarily heating the precursor at an appropriate temperature for an appropriate time, and the opposite substrates are adhered together in an intended state with sandwiching the seal wall precursor and the liquid crystal layer therebetween, using the seal wall precursor. Thus, the opposite substrates can be reliably bonded together while keeping a predetermined gap therebetween, and suppressing dissolving of the seal wall material in the liquid crystal. After bonding of the substrates, the seal wall precursor is fully heated at a predetermined temperature for providing the final seal wall.

It must be taken into consideration that the seal wall material such as thermosetting resin, which is hardened by heating, has the hardness which is variable depending on the temperature and time of the preliminary heating. Further, this hardness will gradually increase, e.g., owing to progress of reaction of the material depending on the elapsed time after the preliminary heating. Accordingly, such a phenomenon may occur that the material, which was subjected to the preliminary heating for a short time, and was left thereafter for a long time, has the same hardness as the material, which was subjected to the preliminary heating for a long time, and was left thereafter only for a short time.

In any one of the above cases, if the seal wall precursor were excessively soft, it would flow or collapse when bonding the substrates, and therefore would not form an intended wall. In the case where the bonding of the substrates is performed while filling the gap with the liquid crystal, the seal wall material is liable to dissolve in the liquid crystal. If the hardness were excessively high, the bonding (adhesion) itself of the substrates would become difficult, or the gap between the substrates would become irregular, especially at the vicinity of the seal wall even if the substrates could be bonded together.

For achieving intended lamination or bonding of the substrates, it is necessary to control appropriately the hardness of the seal wall precursor by controlling the temperature and time of heating in the preliminary heating step prior to the bonding of the substrates as well as the time elapsed after the preliminary heating and before the start of the substrate bonding.

For manufacturing the plurality of liquid crystal panels or the layered type liquid crystal panel having the plurality of liquid crystal panels layered together, attention must be paid to the following points. For manufacturing the liquid crystal panel, it is necessary to control appropriately the hardness of the seal wall precursor by controlling the temperature and time of heating in the step of preliminarily heating the seal wall precursor on each substrate as well as the time elapsed after the preliminary heating and before the start of the substrate bonding, depending on a performance of substrate bonding processing. For example, the conditions (temperature and time) for preliminarily heating the seal wall precursor on each substrate must be controlled in view of the time from the preliminary heating to the substrate bonding, depending on a performance of substrate bonding processing.

Based on the above findings, the invention provides the following methods of manufacturing the liquid crystal panels and the multilayer (layered type) liquid crystal panels.

(1) Method of Manufacturing Liquid Crystal Panel (in Other Words, Liquid Crystal Display Cell)

(1-1) First Type of Method of Manufacturing Liquid Crystal Panel

A manufacturing method of a liquid crystal panel having first and second substrates between which a liquid crystal layer and a seal wall surrounding the liquid crystal layer are sandwiched, said manufacturing method comprising the steps of:

(a) forming a precursor of a material of the seal wall on the first substrate;

(b) executing a preliminary hardening of the precursor formed on the first substrate;

(c) laminating, after a time lapse from a completion of the step (b), the first and second substrates with sandwiching the preliminarily hardened seal wall therebetween, the time lapse being set so that the precursor of the material of the seal wall hardens to a hardness suitable for laminating the first and second substrates; and

(d) executing, after the step (c), a main hardening of the material of the seal wall.

(1-2) Second Type of Method of Manufacturing Liquid Crystal Panel

A manufacturing method of a plurality of liquid crystal panels each having first and second substrates between which a liquid crystal layer and a seal wall surrounding the liquid crystal layer are sandwiched, said manufacturing method comprising the steps of:

(a) forming a precursor of a material of the seal wall on each of the first substrates;

(b) simultaneously starting preliminary hardenings of the precursors formed on the first substrates;

(c) sequentially completing the preliminary hardenings of the precursors formed on the first substrates;

(d) laminating, in an order from the first substrate of which the preliminary hardening is lastly completed to the first substrate of which the preliminary hardening is firstly completed, the first substrates and the second substrates, respectively; and

(e) executing, after the step (d), a main hardening of each of the materials of the seal walls.

In each first substrate, the time elapsed from the completion of the preliminary hardening of the precursor in the step (c) to the step (d) is desirably determined to provide the seal wall precursor having an intended hardness in the step (d).

In other words, the above method is performed such that preliminary hardening of the unhardened seal wall precursors on the respective first substrates start simultaneously, and the preliminary hardening time of the seal wall precursor on each first substrate is changed in view of the elapsed time before the start of the substrate lamination or bonding of the first substrate.

In this method, the preliminary hardening of the unhardened seal wall precursors on the plurality of first substrates start simultaneously. However, consideration is given to the fact that the hardness of the seal wall precursor increases in accordance with the elapsed time before the start of the substrate lamination after the preliminary hardening. Therefore, in view of the laminating performance, procedure and others, the preliminary hardening of the seal wall precursor on the first substrate to be subjected to a later laminating operation is ended relatively early for increasing the elapsed time before the start of lamination, and the preliminary hardening of the seal wall precursor on the first substrate to be subjected to an early laminating operation is ended relatively later for reducing the elapsed time before the start of lamination.

(1-3) Third Type of Method of Manufacturing Liquid Crystal Panel

A manufacturing method of a plurality of liquid crystal panels each having first and second substrates between which a liquid crystal layer and a seal wall surrounding the liquid crystal layer are sandwiched, said manufacturing method comprising the steps of:

(a) forming a precursor of a material of the seal wall on each of the first substrates;

(b) starting preliminary hardenings of the precursors formed on the first substrates in a predetermined order among the first substrates;

(c) completing, in the predetermined order, the preliminary hardenings of the precursors formed on the first substrates;

(d) laminating, in the predetermined order, the first substrates and the second substrates with sandwiching the preliminarily hardened seal wall therebetween, respectively; and

(e) executing, after the step (d), a main hardening of each of the materials of the seal walls.

In this method, preliminary hardening conditions for each first substrate are preferably the same as those for the other first substrates, and the preliminary hardening is preferably executed at predetermined time intervals in accordance with the foregoing predetermined order. Thus, the hardening time for preliminarily hardening for each first substrate is preferably equal to those for the other first substrates, whereby the steps (c) and (d) are executed at predetermined time intervals in accordance with the foregoing predetermined order.

In each first substrate, the time elapsed from the completion of the preliminary hardening of the precursor in the step (c) to the step (d) is preferably determined to provide the seal wall precursor having an intended hardness in the step (d).

In other words, the above method is performed in view of the times elapsed before start of the lamination of the respective first substrates, and thus is performed such that preliminary hardening of the unhardened seal wall precursors on the respective first substrates successively start at shifted times, and also successively end at shifted times. Thereby, the first substrates having seal wall precursors, of which preliminary hardening is completed, are successively subjected to the lamination.

In each of the foregoing methods of manufacturing the liquid crystal panels, the first and second substrates can be reliably laminated and bonded, and the gap between the substrates can be uniform even at the vicinity of the seal wall. Further, it is possible to suppress dissolving of the seal wall material in the liquid crystal. Accordingly, the liquid crystal panel capable of good display can be manufactured.

(2) Method of Manufacturing Multilayer (Layered Type) Liquid Crystal Panel (in Other Words, Multilayer (Layered Type) Liquid Crystal Display Cell)

(2-1) First Type of Method of Manufacturing Layered Type Liquid Crystal Panel

A manufacturing method of a layered type liquid crystal panel in which a plurality of liquid crystal panels are laminated each other, each of said liquid crystal panels having first and second substrates between which a liquid crystal layer and a seal wall surrounding the liquid crystal layer are sandwiched, said manufacturing method comprising the steps of:

(A) preparing the plurality of liquid crystal panels by executing the first type liquid crystal panel manufacturing method, the second type liquid crystal panel manufacturing method, or the third type liquid crystal panel manufacturing method; and

(B) laminating the plurality of panels prepared in the step (A) each other.

(2-2) Second Type of Method of Manufacturing Layered Type Liquid Crystal Panel

A manufacturing method of a layered type liquid crystal panel in which a plurality of liquid crystal panels are laminated each other, each of said liquid crystal panels having first and second substrates between which a liquid crystal layer and a seal wall surrounding the liquid crystal layer are sandwiched, said manufacturing method comprising the steps of:

(A) preparing an uncompleted panel of each of the liquid crystal panels by executing the steps (a) through (c) of the first type liquid crystal panel manufacturing method, the steps (a) through (d) of the second type liquid crystal panel manufacturing method, or the steps (a) through (d) of the third type liquid crystal panel manufacturing method;

(B) laminating the plurality of uncompleted panels each other; and

(C) simultaneously executing, after the step (B), main hardenings of the seal wall materials of the laminated uncompleted panels.

(2-3) Third Type of Method of Manufacturing Layered Type Liquid Crystal Panel

A manufacturing method of a layered type liquid crystal panel in which a plurality of liquid crystal panels are laminated each other, each of said liquid crystal panels having first and second substrates between which a liquid crystal layer and a seal wall surrounding the liquid crystal layer are sandwiched, said manufacturing method comprising the steps of:

(A) preparing each of the first substrates with a preliminarily hardened precursor of a material of the seal wall by executing the steps (a) through (b) of the first type liquid crystal panel manufacturing method, the steps (a) through (c) of the second type liquid crystal panel manufacturing method, or the steps (a) through (c) of the third type liquid crystal panel manufacturing method;

(B) alternately laminating the first substrates and the second substrates to provide laminated uncompleted panels; and

(C) simultaneously executing, after the step (B), main hardenings of the seal wall materials of the laminated uncompleted panels.

In any one of the foregoing methods of manufacturing layered type liquid crystal panels, the first and second substrates in each liquid crystal panel can be reliably bonded, and the gap between the substrates, especially in the region near the seal wall can be uniform. Further, it is possible to suppress dissolving of the seal wall material in the liquid crystal. Accordingly, the layered type liquid crystal panel capable of good display can be manufactured.

In any one of the methods of manufacturing the liquid crystal panels and the methods of manufacturing the layered type liquid crystal panels described above, the precursor used as the material of the seal wall may be a material which can be heated to attain an intended hardness. In this case, the preliminary hardening and full or main hardening of the seal wall precursor can be performed by heating the same. It is preferable that the material used as the seal wall is resin. In this case, monomer or oligomer, which will be hardened to form the foregoing resin, naturally can be used as the foregoing precursor, and liquid or semi-liquid substance of the foregoing resin dissolved in a solvent can also be used as the foregoing precursor.

In any one of the methods of manufacturing the liquid crystal panels and the methods of manufacturing the multilayer liquid crystal panels described above, the first and second substrates of each liquid crystal panel are usually provided with electrodes for displaying images by driving the liquid crystal layer. If necessary, an orientation film, an insulating film and others may be formed.

The liquid crystal layer may contain a spacer for providing a uniform gap (space) between the opposite substrates throughout the panel, and more preferably may contain spherical spacers. The spacers may be dispersed in advance on the substrate (e.g., the first substrate on which the seal wall precursor is to be arranged), or may be dispersed in the liquid crystal material so that the spacers may be dispersed between the opposite substrates when the liquid crystal layer is held between the substrates in the substrate laminating step. The seal wall may also contain the spacers.

The liquid crystal layer may contain a resin structure such as resin columns for the purpose(s) of providing the uniform space (gap) between the substrates throughout the panel and/or coupling the substrates together. The resin structure may be formed in advance on the substrate, e.g., the second substrate, using, e.g., thermoplastic resin.

### BRIEF DESCRIPTION OF THE DRAWINGS

These and other objects, advantages and features of the invention will become apparent from the following description thereof taken in conjunction with the accompanying drawings in which:

FIG. 1 is a schematic cross section showing by way of example a liquid crystal panel to be manufactured according to the method of the invention;

FIG. 2 shows an example of manufacturing the liquid crystal panel shown in FIG. 1;

FIG. 3 is a schematic side view showing by way of example a multilayer liquid crystal panel to be manufactured according to the method of the invention;

FIG. 4 shows an example of manufacturing the multilayer liquid crystal panel shown in FIG. 3;

FIG. 5 shows elapsed times in respective steps of an experimental example 2; and

FIG. 6 shows elapsed times in respective steps of an experimental example 3.

### DETAILED DESCRIPTION OF THE PREFERRED EMBODIMENTS

Embodiments of the invention will now be described below.

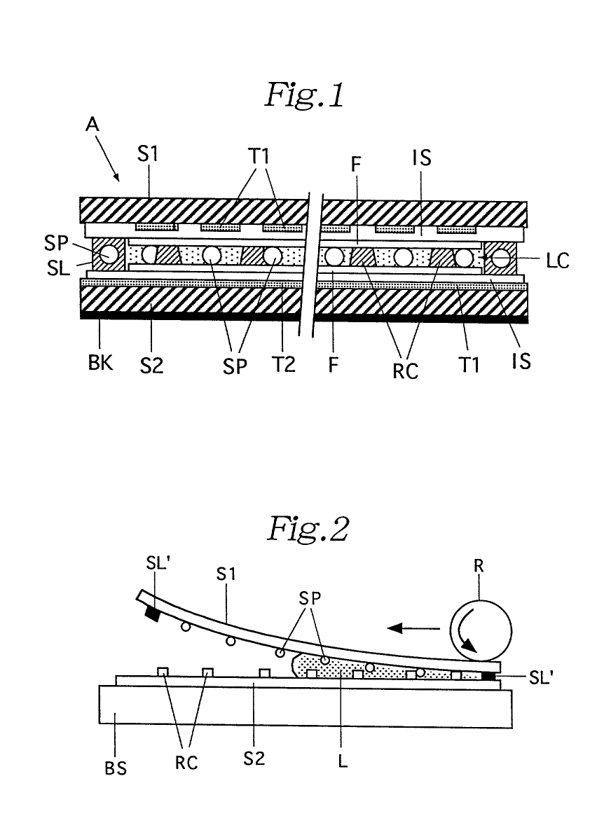

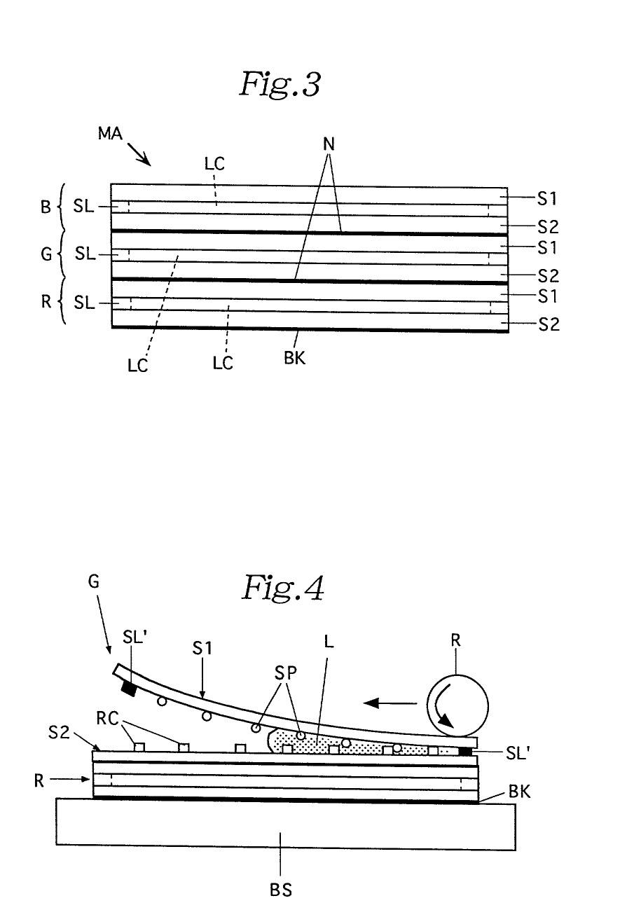

FIG. 1 is a cross section showing a schematic structure of an example of a liquid crystal panel to be manufactured by a method employing the invention. FIG. 3 is a side view showing a schematic structure of an example of a multilayer (layered type) liquid crystal panel formed of three layered liquid crystal panels, each of which is of the same type as that shown in FIG. 1.

A liquid crystal panel (liquid crystal display cell) A shown in FIG. 1 is of a reflection type.

In this liquid crystal panel A, a pair of transparent substrates S1 and S2 are opposed to each other, and hold therebetween a liquid crystal layer LC, which contains a liquid crystal material exhibiting a cholesteric phase for image display in a predetermined color.

An electrode T1 is formed on a surface of the first substrate S1 opposed to the liquid crystal layer LC. An electrode T2 is formed on a surface of the second substrate S2 opposed to the liquid crystal layer LC. The electrode T1 is formed of a plurality of narrow belt-like electrodes, which are parallel to the short side of the substrate S1 (extending normal to the sheet of FIG. 1). The electrode T2 is likewise formed of a plurality of narrow belt-like electrodes, which are parallel to the long side of the substrate S2 (lateral direction in FIG. 1), and therefore extend perpendicularly to the electrode T1.

Each of the substrates S1 and S2 is further provided with an insulating film IS and an orientation film F.

The liquid crystal layer LC contains spacers SP and resin columns RC. The spacers SP are employed for maintaining a predetermined space between the opposite substrates. The resin columns RC are employed for maintaining a predetermined space between the opposite substrates and for coupling the opposite substrates together, although not restricted to these purposes.

The structure is also provided with a seal wall SL for surrounding the liquid crystal layer LC and sealing the space between edge of portions of the opposite substrates. The resin columns RC may be made of a thermoplastic resin, and the seal wall SL may be made of a material such as thermosetting resin, which is hardened when heated, although not restricted thereto. More specifically, the resin columns RC in this example are made of polyurethane resin, and the seal wall SL is made of two-part epoxy resin. The seal wall may be made of various kinds of setting or curing materials other than the thermosetting material, and may be a photo-setting material such as an ultraviolet-curing material, a radiation-curing material or the like. However, the photo-setting material is generally liable to dissolve in the liquid crystal, and the quality thereof may change due to irradiation with light for full or main hardening. Therefore, the seal wall may be made of a thermosetting material, which is less susceptible to the above failures.

By using the two-part epoxy resin containing the spherical spacers SP dispersed therein, the seal wall SL is formed in such a manner that a seal wall precursor is formed in advance on the first substrate S1, e.g., by a printing method, and then is heated to form the seal wall.

The other spacers SP are dispersed in advance on the first substrate S1. The resin columns RC are formed in advance on the second substrate S2, e.g., by the printing method.

The liquid crystal panel A of the reflection type can be manufactured, e.g., in the following manner.

In advance, the electrode T1, the insulating film IS and the orientation film F are formed on the transparent substrate S1, which is made of polycarbonate and has a resistance against heating at about 140° C. A precursor SL′ (see FIG. 2) of the seal wall SL is formed on one side of the substrate S1, and the spacers SP are dispersed on the same side thereof. Also, the resin columns RC are formed on one side of the transparent substrate S2, which is provided with the electrode T2, the insulating film IS and the orientation film F, is made of polycarbonate and thus is resistant to the heating at about 140° C.

The resin columns RC and the seal wall precursor SL′ thus formed have heights slightly larger than the predetermined height. If necessary, a black light absorbing layer BK is formed on an outer surface of the substrate S2.

The resin columns RC may be formed independently of each other, but may have a partially or entirely continuous form. The resin column may have a form, e.g., of a column having a circular section, apolygonal section or the like, or a wall.

Then, the substrate S1 is placed in an oven, and the seal wall precursor SL′ is preliminarily heated at a predetermined temperature for a predetermined time to achieve a predetermined hardness (predetermined semi-hard state).

Then, as shown in FIG. 2, the substrate S2 is arranged on a base BS, and a liquid crystal material L is applied to an end of the surface of the substrate S2 carrying the resin columns RC. Further, an end of the substrate S1 carrying the preliminarily heated seal wall precursor SL′ is laid over an end of the substrate S2 such that the surface of the substrate S1 carrying the seal wall precursor SL′ and one surface of the substrate S2 are opposed to each other with the liquid crystal material L therebetween.

A pressure roller R is operated together with the base BS to press successively the substrates S1 and S2 against each other. At the same time, the liquid crystal material L is spread between the substrates, and the substrates are bonded together owing to an adhesion of the seal wall precursor SL′.

The substrates S1 and S2 thus bonded are put in the oven, and are heated at a predetermined temperature so that the seal wall precursor is fully heated to form the final seal wall SL. Also, the resin columns RC are finally bonded to both the substrates.

The seal wall SL and others are pressed and adjusted to attain a height, which achieves the predetermined distance between the opposite substrates. In this manner, the liquid crystal panel A of the reflection type is completed.

A multilayer liquid crystal panel MA shown in FIG. 3 includes a liquid crystal panel B for blue display, a liquid crystal panel G for green display and a liquid crystal panel R for red display. These panels are layered for performing full color image display. The neighboring panels B and G are bonded together by an adhesive N, and the neighboring panels G and R are bonded together by the adhesive N. Each of the liquid crystal panels G, B and R has the basically same structure as the liquid crystal panel A shown in FIG. 1, but the black light absorbing layer BK is arranged on only the outer surface of the panel R.

Each of the panels G, B and R includes the liquid crystal layer LC, which is held between the paired transparent substrates S1 and S2, for image display in the predetermined color.

The panels B, G and R may be overlaid and bonded together after these panels B, G and R are manufactured independently of each other. Alternatively, such a manner maybe employed that the panel (e.g., panel R) to be located at the outermost position is formed similarly to the foregoing manner. Then, as shown in FIG. 4, the second substrate S2 for the next panel G, which is adhered in advance to one of the substrates of the panel R by the adhesive N, is bonded to the first substrate, which is already provided with the preliminarily heated seal wall precursor for the panel G, in the manner similar to that shown in FIG. 2 so that the seal wall precursor and the liquid crystal layer are held between the first and second substrates for the panel G. In a similar manner, the panel B may be formed on the panel G.

The full heating of the seal wall precursors of the panels B, G and R may be performed simultaneously after layering the precursors, which are not yet fully heated.

Description will now be given successively on experimental examples of manufacturing of the liquid crystal panel of the type shown in FIG. 1, and experimental examples of manufacturing of the multilayer liquid crystal panel of the type shown in FIG. 3. Comparative experimental examples will also be described. In the following description, the first and second substrates S1 and S2 are made of polycarbonate resin. The seal wall SL or its precursor SL′ is made of two-part epoxy resin, and the resin columns RC are made of polyurethane resin.

### EXPERIMENTAL EXAMPLE 1

### An Example of Manufacturing of the Liquid Crystal Panel in FIG. 1

The spacers were dispersed on the first substrate S1, and the seal wall precursor SL′ was formed by the printing method. The resin columns RC were formed on the second substrate S2. The electrodes and others were also formed on the substrates S1 and S2.

Before bonding the substrates, the first substrate S1 was put in the oven, and the seal wall precursor SL′ on the substrate was preliminarily heated at 140° C. for 7 minutes and 30 seconds.

After 30 minutes elapsed from the preliminary heating, the second substrate S2 and the first substrate S1 already subjected to the preliminary heating were bonded together while filling the gap with the liquid crystal material.

After the bonding, the seal wall precursor SL′ was fully heated in the oven at 80° C.

When 30 minutes elapsed from the preliminary heating, the seal wall precursor attained an appropriate hardness. In this state, the substrates were bonded together. Therefore, the liquid crystal panel thus obtained had such features that the seal wall material had not dissolved in the liquid crystal, and the uniform gap could be kept between the substrates even at the vicinity of the seal wall.

### COMPARATIVE EXPERIMENTAL EXAMPLE 1

### Another Example of Manufacturing of the Liquid Crystal Panel in FIG. 1

Similarly to the experimental example 1, the spacers, seal wall precursor, resin columns and others were formed on the substrates.

Before bonding the first and second substrates, the first substrate S1 was placed in the oven, and the seal wall precursor SL′ on the substrate was preliminarily heated at 140° C. for 8 minutes.

Upon elapsing of 2 hours from the preliminary heating, the second substrate S2 and the first substrate S1 already subjected to the preliminary heating were bonded together while filling the gap with the liquid crystal material.

After the bonding, the seal wall precursor SL′ was fully heated in the oven at 80° C.

In the liquid crystal panel thus obtained, the seal wall material had not dissolved in the liquid crystal. However, the seal wall had not been compressed to the predetermined height because the substrates were bonded after two hours elapsed from the preliminary heating, and thus after the hardness of the seal wall precursor was increased. Therefore, the gap formed between the substrates at the vicinity of the seal wall was excessively large.

### COMPARATIVE EXPERIMENTAL EXAMPLE 2

### A Further Example of Manufacturing of the Liquid Crystal Panel in FIG. 1

Similarly to the experimental example 1, the spacers, seal wall precursor, resin columns and others were formed on the substrates.

Before bonding the first and second substrates, the first substrate S1 was put in the oven, and the seal wall precursor SL′ on the substrate was preliminarily heated at 140° C. for 7 minutes and 30 seconds.

Immediately after the preliminary heating, the second substrate S2 and the first substrate S1 already subjected to the preliminary heating were bonded together while filling the gap with the liquid crystal material.

After the bonding, the seal wall precursor SL′ was fully heated in the oven at 80° C.

As compared with the experimental example 1, the preliminary heating time was the same, but the substrates were bonded immediately after the preliminary heating, and thus before the seal wall precursor attained an appropriate hardness. Therefore, the seal wall material dissolved in the liquid crystal, and a display failure occurred in the liquid crystal panel thus produced.

### EXPERIMENTAL EXAMPLE 2

### An Example of Manufacturing of a Plurality of Liquid Crystal Panels in FIG. 1

Ten sets of the first and second substrates were prepared, and the spacers, seal wall precursor, resin columns and others were formed thereon similarly to the experimental example 1.

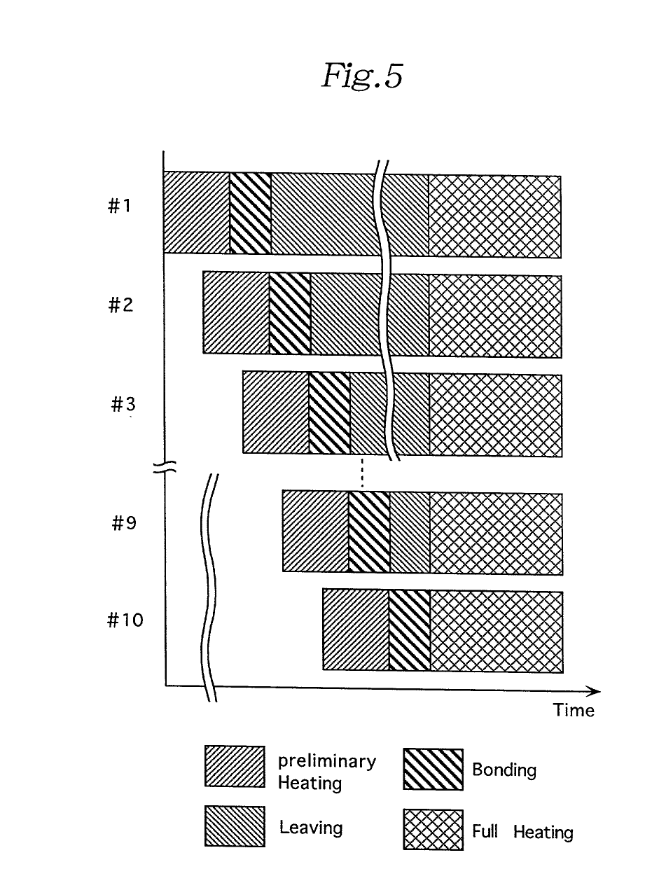

First, as shown in FIG. 5, only one of the ten first substrates S1 was put in the oven, and the preliminary heating of the seal wall precursor SL′ was started at 140° C. When 8 minutes elapsed after the start of preliminary heating, the first substrate was removed from the oven to end the preliminary heating. Immediately after the preliminary heating, the first substrate S1 was bonded to the second substrate S2 while filling the gap with the liquid crystal material. About five minutes elapsed from the time of removal of the first substrate from the oven to the completion of bonding of the first and second substrates.

Thereafter, the nine first substrates except for the foregoing one substrate were successively put in the oven at intervals of 5 minutes after start of the first preliminary heating of the first substrate, and were subjected to the preliminarily heating and the bonding to the second substrates under the same conditions as the initial first substrate.

After the bonding of all the substrates, the seal wall precursors of all the precursor panels were simultaneously subjected to the full heating in the oven at 80° C.

In this example, each of the liquid crystal panels was formed by preliminarily heating the seal wall precursor under such conditions that an appropriate hardness could be achieved immediately after the preliminary heating. In each liquid crystal panel, therefore, the seal wall material did not dissolve in the liquid crystal, and the gap between the substrates could be uniform even at the vicinity of the seal wall.

In FIG. 5, #1, #2, #3, . . . indicate the substrates for the first, second, third, . . . operations, respectively.

### EXPERIMENTAL EXAMPLE 3

### Another Example of Manufacturing of a Plurality of Liquid Crystal Panels in FIG. 1

Ten sets of the first and second substrates were prepared, and the spacers, seal wall precursor, resin columns and others were formed thereon similarly to the experimental example 1.

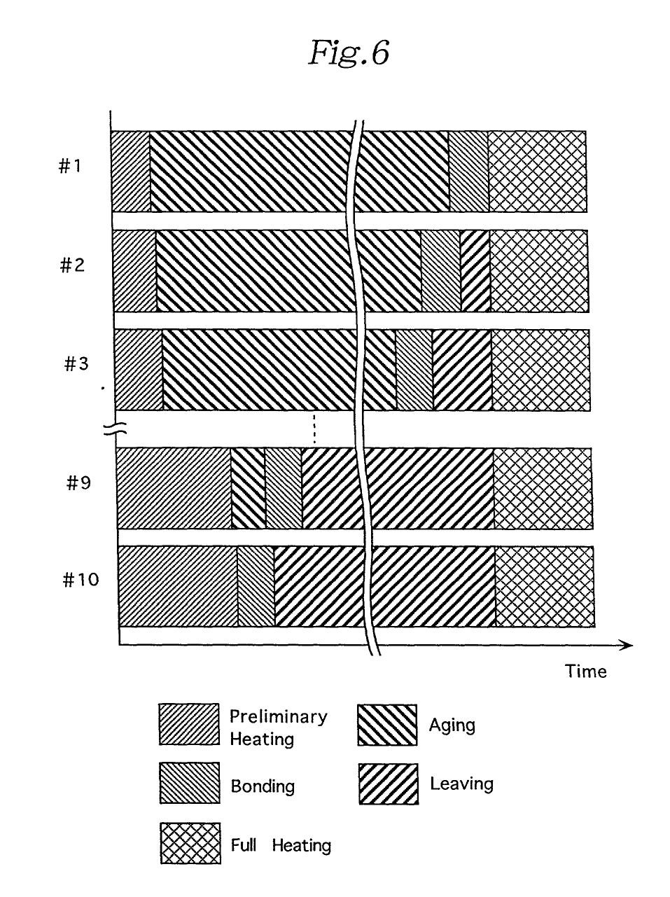

First, as shown in FIG. 6, the ten first substrates S1 were simultaneously put in the oven, and the preliminary heating was started at 140° C.

When 6 minutes and 30 seconds elapsed, one of the substrates was removed, and then the other substrates were successively removed from the oven at intervals of 10 seconds. The last substrate was removed after 8 minutes.

Immediately after the preliminary heating, the last first substrate S1 removed from the oven was bonded to the second substrate S2 while filling the gap with the liquid crystal material. The first substrate S1 removed by the ninth operation was bonded to the second substrate when 10 minutes elapsed after the removal thereof. Similarly, each of the first substrates removed by the eighth, seventh, . . . operations in this order were bonded to the second substrates upon every elapsing of 10 minutes after the removal. Thus, the first substrate, which had been preliminarily heated for the shortest time, was bonded by the last bonding operation. This first substrate S1, which had been preliminarily heated for the shortest time, was bonded when 90 minutes elapsed after the end of the preliminary heating.

After the bonding of all the substrates, the seal wall precursors of the precursor panels were simultaneously subjected to the full heating in the oven at 80° C.

In each of the liquid crystal panels including the liquid crystal panels, which were subjected to the first bonding and the last bonding, the seal wall material did not dissolve in the liquid crystal, and the gap between the substrates could be uniform even at the vicinity of the seal wall.

In FIG. 6, #1, #2, #3, . . . indicate the substrates for the first, second, third, . . . positions, respectively.

### COMPARATIVE EXPERIMENTAL EXAMPLE 3

### A Further Example of Manufacturing of a Plurality of Liquid Crystal Panels in FIG. 1

Ten sets of the first and second substrates were prepared, and the spacers, seal wall precursor, resin columns and others were formed thereon similarly to the experimental example 1.

All the 10 first substrates S1 were simultaneously put in the oven, and the preliminary heating of the seal wall precursors SL′ were executed at 140° C. for 8 minutes.

After the preliminary heating, all the first substrates S1 were simultaneously removed from the oven. The respective first substrates were successively bonded to the second substrates at time intervals of 5 minutes while filling the gaps with the liquid crystal material.

After all the substrates were bonded, the seal wall precursors of all the precursor panels were fully heated at the same time in the oven at 80° C.

As described above, the preliminary heating conditions similar to those of the experimental example 1 were employed for preliminarily heating the seal wall precursor on each first substrate, but the respective first substrates were processed with different elapsed times after the preliminary heating and before the substrate bonding. Therefore, in the liquid crystal panel obtained by the last substrate bonding, the seal wall was not compressed to the predetermined height similarly to the comparative experimental example 1, and the gap between the substrates near the seal wall was larger than that of the liquid crystal panel obtained by the initial substrate bonding.

### EXPERIMENTAL EXAMPLE 4

### An Example of Manufacturing of the Multilayer Liquid Crystal Panel in FIG. 3

Three sets of the first and second substrates were prepared, and the spacers, seal wall precursor, resin columns and others were formed thereon similarly to the experimental example 1.

Only one of the three first substrates S1 was put in the oven, and the seal wall precursor was preliminarily heated at 140° C. for 8 minutes. Then, one of the second substrates S2 and the first substrate S1 already subjected to the preliminary heating were bonded together while filling the gap with the liquid crystal material for red display.

The other two first substrates S1 were successively put in the oven at intervals of 5 minutes after elapsing of 5 minutes from the start of first preliminary heating of the first substrate S1, and the preliminary heating was performed under the same conditions as the first preliminary heating of the first substrate. Immediately after the second preliminary heating of the first substrate was completed, the second substrate S2 and the first substrate S1 subjected to the second processing were bonded while filling the gap with the liquid crystal material for green display. Similarly, immediately after the third preliminary heating of the first substrate was completed, the remaining second substrate S2 and the first substrate S1 subjected to the third processing were bonded while filling the gap with the liquid crystal material for blue display.

When all the substrates were bonded, the seal wall precursors of all the precursor panels obtained by the above manner were fully heated at the same time in the oven at 80° C.

As a result, dissolving of the seal wall material in the liquid crystal did not occur in any one of the liquid crystal panels R, G and B, and the gap between the substrates could be uniform even at the vicinity of the seal wall.

These panels were layered and adhered to produce a color liquid crystal panel. This color liquid crystal panel entirely had a uniform thickness, had no distortion, and could achieve good display.

### COMPARATIVE EXPERIMENTAL EXAMPLE 4

### Another Example of Manufacturing of the Multilayer Liquid Crystal Panel in FIG. 3

Three sets of the first and second substrates were prepared, and the spacers, seal wall precursor, resin columns and others were formed thereon similarly to the experimental example 1.

The three first substrates S1 were simultaneously put in the oven, and the seal wall precursors were preliminarily heated at 140° C. for 8 minutes.

After the preliminary heating, all the three first substrates were simultaneously removed from the oven. One of these first substrates and the corresponding second substrate were bonded while filling the gap with the liquid crystal material for red display. After the interval of 5 minutes, the first substrate other than the above and the corresponding second substrate were bonded while filling the gap with the liquid crystal material for green display. Further, after the interval of 5 minutes, the last first substrate and the corresponding second substrate were bonded while filling the gap with the liquid crystal material for blue display.

After all the substrates were bonded, the seal wall precursors of all the precursor panels obtained by the above manner were fully heated at the same time in the oven at 80° C.

Among these liquid crystal panels thus prepared, the liquid crystal panel B subjected to the last bonding was not compressed to have a predetermined height in contrast to the liquid crystal panel R subjected to the first bonding, and thus had a large gap between the substrates at the vicinity of the seal wall.

A color liquid crystal panel was produced by layering these panels. Since the panels R, G and B had different thicknesses at the vicinity of the seal walls, respectively, a distortion occurred in the color display panel.

### EXPERIMENTAL EXAMPLE 5

### An Example of Manufacturing in FIG. 4 of the Multilayer Liquid Display Device in FIG. 3

Three sets of the first and second substrates were prepared, and the spacers, seal wall precursor, resin columns and others were formed thereon similarly to the experimental example 1.

Only one of the three first substrates S1 was put in the oven, and the preliminary heating of the seal wall precursor was started at 140° C. After 10 minutes from the start of the first preliminary heating of the first substrate S1, the next first substrate S1 was put in the oven. After 10 minutes therefrom, the last first substrate S1 was put in the oven. The preliminary heating of the seal wall precursor of the first substrates S1 for the second and third processing was started at the same temperature as that for the first operation. This preliminary heating of the precursor of each first substrate was performed for 8 minutes.

When the preliminary heating was performed for 8 minutes, the first substrate for the first processing was removed from the oven. Immediately after this preliminary heating, the first substrate S1 thus processed and the second substrate S2 were bonded together while filling the gap with the liquid crystal material for red display in the method shown in FIG. 2.

After 5 minutes from the start of the above first bonding of the first substrate S1, the first substrate S1 for the red display panel was bonded to the second substrate S2 for a green display panel with an adhesive sheet.

After 5 minutes from the start of the above bonding of the second substrate S2 for the green display panel, the first substrate S1 for the second processing, of which preliminary heating for 8 minutes was just completed, was bonded to the second substrate S2 already bonded for the red display panel, and at the same time, filling the gap with the liquid crystal material for green display was performed in the method shown in FIG. 4.

After 5 minutes from the start of the substrate bonding for the green display panel, the first substrate S1 for the green display panel was bonded to the second substrate S2 for a blue display panel with the adhesive sheet.

After 5 minutes from the start of the above bonding of the second substrate S2 for the blue display panel, the first substrate S1 for the third processing, of which preliminary heating for 8 minutes was just completed, was bonded to the second substrate S2 already bonded for green display panel, and at the same time, filling the gap with the liquid crystal material for blue display was performed in the method shown in FIG. 4.

Finally, all the precursors of the layered panels for red, green and blue display were fully heated at the same time in the oven at 80° C.

As a result, dissolving of the seal wall material in the liquid crystal did not occur in any one of the liquid crystal panels R, G and B, and the gap between the substrates could be uniform even at the vicinity of the seal wall.

These panels were layered and adhered to produce a color liquid crystal panel. This color liquid crystal panel entirely had a uniform thickness, had no distortion, and could achieve good display.

### COMPARATIVE EXPERIMENTAL EXAMPLE 5

### Another Example of Manufacturing in FIG. 4 of the Multilayer Liquid Crystal Panel in FIG. 3

Three sets of the first and second substrates were prepared, and the spacers, seal wall precursor, resin columns and others were formed thereon similarly to the experimental example 1.

The three first substrates S1 were simultaneously put in the oven, and the seal wall precursors were preliminarily heated at 140° C. for 8 minutes.

After the preliminary heating, all the three first substrates were removed from the oven. One of these first substrates and the corresponding second substrate were bonded while filling the gap with the liquid crystal material for red display in the method shown in FIG. 2.

After elapsing of 5 minutes from the start of bonding of the substrates for a red display panel, the first substrate S1 of the red display panel was bonded to the second substrate S2 for a green display pane with the adhesive sheet. Further, after the interval of 5 minutes, one of the remaining first substrates S1 already subjected to the preliminary heating and the corresponding substrate were bonded while filling the gap with the liquid crystal material for green display in the method shown in FIG. 4.

After elapsing of 5 minutes from the start of bonding of the substrates for the green display panel, the first substrate S1 of the green display panel and the second substrate S2 for a blue display panel were bonded with an adhesive sheet. Further, after the interval of 5 minutes, the last first substrate S1 already subjected to the preliminary heating and the corresponding substrate were bonded while filling the gap with the liquid crystal material for blue display in the method shown in FIG. 4.

Finally, all the precursors of the layered panels for red, green and blue display were fully heated at the same time in the oven at 80° C.

In the color display panel thus produced, particularly a seal wall portion of the panel B had a large thickness, and a distortion occurred in the whole color liquid crystal panel.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A manufacturing method of a liquid crystal panel having first and second substrates between which a liquid crystal layer and a seal wall surrounding the liquid crystal layer are sandwiched, said manufacturing method comprising the steps of:
(a) forming a precursor of a material of the seal wall on the first substrate;
(b) executing a preliminary hardening of the precursor formed on the first substrate;
(c) laminating, after a time lapse from a completion of the step (b), the first and second substrates with sandwiching the preliminarily hardened seal wall therebetween, the time lapse being set so that the precursor of the material of the seal wall hardens to a hardness suitable for laminating the first and second substrates; and
(d) executing, after the step (c), a main hardening of the material of the seal wall.

2. A manufacturing method as claimed in claim 1, wherein the precursor is capable of hardening by being heated.

3. A manufacturing method as claimed in claim 2, wherein the preliminary hardening of the precursor is executed by heating the precursor.

4. A manufacturing method as claimed in claim 2, wherein the material of the seal wall is a thermosetting resin.

5. A manufacturing method as claimed in claim 1, wherein, in the step (c), the first and second substrates are laminated with sandwiching the preliminarily hardened seal wall and a liquid crystal material of the liquid crystal layer therebetween.

6. A manufacturing method of a plurality of liquid crystal panels each having first and second substrates between which a liquid crystal layer and a seal wall surrounding the liquid crystal layer are sandwiched, said manufacturing method comprising the steps of:
(a) forming a precursor of a material of the seal wall on each of the first substrates;
(b) simultaneously starting preliminary hardenings of the precursors formed on the first substrates;
(c) sequentially completing the preliminary hardenings of the precursors formed on the first substrates;
(d) laminating, in an order from the first substrate of which the preliminary hardening is lastly completed to the first substrate of which the preliminary hardening is firstly completed, the first substrates and the second substrates, respectively; and
(e) executing, after the step (d), a main hardening of each of the materials of the seal walls.

7. A manufacturing method as claimed in claim 6, wherein the precursor is capable of hardening by being heated.

8. A manufacturing method as claimed in claim 7, wherein the preliminary hardening of the precursor is executed by heating the precursor.

9. A manufacturing method as claimed in claim 7, wherein the material of the seal wall is a thermosetting resin.

10. A manufacturing method as claimed in claim 6, wherein, for each of the first substrates, the lamination of the first substrate and the second substrate in the step (d) is executed after a time lapse from the completion of the preliminary hardening of the precursor formed on the first substrate in the step (c).

11. A manufacturing method as claimed in claim 10, wherein the time lapse is set so that the precursor of the material of the seal wall hardens to a hardness suitable for laminating the first and second substrates.

12. A manufacturing method as claimed in claim 6, wherein, in the step (d), the first and second substrates are laminated with sandwiching the preliminarily hardened seal wall and a liquid crystal material of the liquid crystal layer therebetween.

13. A manufacturing method of a plurality of liquid crystal panels each having first and second substrates between which a liquid crystal layer and a seal wall surrounding the liquid crystal layer are sandwiched, said manufacturing method comprising the steps of:
(a) forming a precursor of a material of the seal wall on each of the first substrates;
(b) starting preliminary hardenings of the precursors formed on the first substrates in a predetermined order among the first substrates;
(c) completing, in the predetermined order, the preliminary hardenings of the precursors formed on the first substrates;
(d) laminating, in the predetermined order, the first substrates and the second substrates with sandwiching the preliminarily hardened seal wall therebetween, respectively; and
(e) executing, after the step (d), a main hardening of each of the materials of the seal walls.

14. A manufacturing method as claimed in claim 13, wherein the precursor is capable of hardening by being heated.

15. A manufacturing method as claimed in claim 14, wherein the preliminary hardening of the precursor is executed by heating the precursor.

16. A manufacturing method as claimed in claim 14, wherein the material of the seal wall is a thermosetting resin.

17. A manufacturing method as claimed in claim 13, wherein, for each of the first substrates, the lamination of the first substrate and the second substrate in the step (d) is executed after a time lapse from the completion of the preliminary hardening of the precursor formed on the first substrate in the step (c).

18. A manufacturing method as claimed in claim 17, wherein the time lapse is set so that the precursor of the material of the seal wall hardens to a hardness suitable for laminating the first and second substrates.

19. A manufacturing method as claimed in claim 13, wherein, in the step (d), the first and second substrates are laminated with sandwiching the preliminarily hardened seal wall and a liquid crystal material of the liquid crystal layer therebetween.

20. A manufacturing method of a layered type liquid crystal panel in which a plurality of liquid crystal panels are laminated each other, each of said liquid crystal panels having first and second substrates between which a liquid crystal layer and a seal wall surrounding the liquid crystal layer are sandwiched, said manufacturing method comprising the steps of:
(A) preparing the plurality of liquid crystal panels by executing the manufacturing method as claimed in claim 1 for each of the liquid crystal panels, the manufacturing method as claimed in claim 6, or the manufacturing method as claimed in claim 13; and
(B) laminating the plurality of panels prepared in the step (A) each other.

21. A manufacturing method of a layered type liquid crystal panel in which a plurality of liquid crystal panels are laminated each other, each of said liquid crystal panels having first and second substrates between which a liquid crystal layer and a seal wall surrounding the liquid crystal layer are sandwiched, said manufacturing method comprising the steps of:
(A) preparing an uncompleted panel of each of the liquid crystal panels by executing the steps (a) through (c) of the manufacturing method as claimed in claim 1 for each of the uncompleted panels, the steps (a) through (d) of the manufacturing method as claimed in claim 6, or the steps (a) through (d) of the manufacturing method as claimed in claim 13;
(B) laminating the plurality of uncompleted panels each other; and
(C) simultaneously executing, after the step (B), main hardenings of the materials of the seal walls of the laminated uncompleted panels.

22. A manufacturing method of a layered type liquid crystal panel in which a plurality of liquid crystal panels are laminated each other, each of said liquid crystal panels having first and second substrates between which a liquid crystal layer and a seal wall surrounding the liquid crystal layer are sandwiched, said manufacturing method comprising the steps of.
(A) preparing each of the first substrates with a preliminarily hardened precursor of a material of the seal wall by executing the steps (a) through (b) of the manufacturing method as claimed in claim 1 for each of the first substrates, the steps (a) through (c) of the manufacturing method as claimed in claim 6, or the steps (a) through (c) of the manufacturing method as claimed in claim 13;
(B) alternately laminating the first substrates and the second substrates to provide laminated uncompleted panels; and
(C) simultaneously executing, after the step (B), main hardenings of the materials of the seal walls of the laminated uncompleted panels.
